(19) United States
(12) Patent Application Publication
(10) Pub. No.: US 2003/0154110 A1
(43) Pub. Date: Aug. 14, 2003

(54) Method and apparatus for wireless access to a health care information system

(76) Inventors: Ervin Walter, Madison, WI (US); Andy Giesler, Madison, WI (US); Chris Theorin, Madison, WI (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/300,229

(22) Filed: Nov. 20, 2002

Related U.S. Application Data
(60) Provisional application No. 60/331,842, filed on Nov. 20, 2001.

(51) Int. Cl. G06F 17/60

(52) U.S. Cl. 705/3

(57) ABSTRACT

A wireless handheld device (WHD) is provided and capable of providing a real-time, persistent, live wireless connection with functionality provided by, and/or information maintained or stored within a health care information system (HCIS). A real-time, live wireless connection with the HCIS allows the user to perform many or all of the same tasks as the users of workstation-based client applications with full access to the HCIS, including modifying information within the HCIS (and a patient health record repository(ies) located therein), and accessing functionality (health care applications) provided by the HCIS.

### CROSS-REFERENCE TO RELATED APPLICATIONS

This application claims priority to U.S. Provisional Patent Application Serial No. 60/331,842, filed Nov. 20, 2001, the disclosure of which is hereby expressly incorporated herein by referenced.

### TECHNICAL FIELD

The present patent is related generally to health care information systems, and more particularly, for allowing real-time access to a health care information system via a wireless handheld device.

### BACKGROUND

Health care enterprises provide various aspects of patient care. In providing the patient care, health care workers typically utilize one or more software applications comprising a health care information system (HCIS) through typically bulky, fixed terminals which require a constant physical connection with the HCIS to operate. As such, the fixed terminals are not readily mobile for users of the HCIS, requiring the users to retrieve information from, and enter information into, the HCIS only at the fixed locations.

To provide more convenient and efficient access to an HCIS, handheld devices have been used. However, in order to use the handheld devices, the information on the wireless handheld device (WHD) must be synchronized with the HCIS by connecting the WHD to a data import/export device connected with the HCIS, or via a cable connected with the HCIS, to allow the exchange of data between the HCIS and the WHD. In this way, the WHD is considered to operate in an asynchronous environment when not connected to the HCIS via the data import/export device or cable. Accordingly, the WHD may not have up-to-date information for a given patient where the patient data has been modified in the HCIS elsewhere after the data on the WHD was synchronized with the HCIS. In such a circumstance, the user of the WHD may unknowingly provide inadequate patient care or be forced to resort to another mode of communication with the HCIS. Further, the WHD may not have necessary information for providing patient care because it was not known that particular patient information would be required at the time of synchronization of the WHD. In this circumstance, the user of the WHD must generate a new, temporary patient record on the WHD, must take the WHD to a physical synchronization terminal for the HCIS, or resort to another mode of communication with the HCIS. Further, where alterations are made to a patient record via the WHD, modified patient data is not available to the HCIS and other users of the HCIS until the WHD is synchronized with the HCIS. This results in the potential for data conflicts for the particular patient on the HCIS which must be solved after the WHD is synchronized, either by a complex set of rules and conditions for data conflicts, or by a user of the HCIS. In the meantime, other users of the HCIS may further or additionally unknowingly modify the same piece of data or provide patient care without complete and up-to-date patient information.

Further, such a WHD cannot effectively provide decision support for an HCIS user because the WHD may not have immediate access to the information required for the decision support process. In addition, such WHDs cannot efficiently participate in work flow messaging and collaboration because any messages and collaboration that have occurred, either on the WHD or from other HCIS users, are not available until the time of the next synchronization of the WHD with the HCIS.

Further, some WHDs rely on one or more intermediate data stores in order to facilitate communication between the WHD and the HCIS, amplifying the problems associated with lack of up-to-date information for data on the HCIS discussed above.

### BRIEF DESCRIPTION OF THE DRAWINGS

FIG. 1a illustrates an overview of a health care information system utilizing a wireless handheld device capable of providing a real-time connection with the health care information system in accordance with an embodiment of the invention;

FIG. 1b illustrates a block diagram of the wireless handheld device of FIG. 1a in accordance with an embodiment of the invention;

FIG. 1c illustrates a message format for transmitting information between the wireless handheld device and the access point in accordance with an embodiment of the invention;

FIG. 2 illustrates functionality of a software application which may be utilized on the wireless handheld device in accordance with an embodiment of the invention;

FIG. 3 is a flow chart illustrating authentication of an HCIS user session utilizing a wireless handheld device in accordance with an embodiment of the invention;

FIG. 4 is a flow chart illustrating the HCIS transaction architecture in accordance with an embodiment of the invention;

FIG. 5 is a flow chart illustrating the acquisition and maintenance of a realtime connection between the wireless handheld device and the HCIS in accordance with an embodiment of the invention;

FIG. 6 is a flow chart illustrating dual-mode functionality of the wireless handheld device in accordance with an embodiment of the invention;

FIG. 7 is a graphic representation of a universal patient record usable within the health care information system in accordance with an embodiment of the invention; and

FIG. 8 is a graphic representation of master files linked with the universal patient record of FIG. 7 in accordance with an embodiment of the invention.

### DETAILED DESCRIPTION OF VARIOUS EMBODIMENTS

Although the following text sets forth a detailed description of numerous different embodiments of the invention, it should be understood that the legal scope of the invention is defined by the words of the claims set forth at the end of a patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent application, which would still fall within the scope of the claims defining the invention.

It should also be understood that, unless a term is expressly defined in this provisional patent application using the sentence “As used herein, the term ‘______’is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent application.

A wireless handheld device (WHD) is provided and capable of providing a real-time, persistent, live wireless connection with functionality provided by, and/or information maintained or stored within a health care information system (HCIS). A real-time, live wireless connection with the HCIS allows the user to perform many or all of the same tasks as the users of workstation-based client applications with full access to the HCIS, including modifying information within the HCIS (and a patient health record repository(ies) located therein), and accessing functionality (health care applications) provided by the HCIS.

For a client application to effectively interact with the HCIS, it must be capable of maintaining a connection in real-time. This real-time connection affords access to HCIS functionality and the most up-to-date patient data, and ensures that only a single user can access a given piece of patient data at a given time. In some cases, proper patient care requires full access to the most recent patient information. In other cases, data conflicts that arise as a result of asynchronous operations may require a complex set of rules to solve these conflicts, or they may have to be resolved manually.

In order to interact with the HCIS in this fashion, the client application on the WHD establishes and maintains a secure, user-specific, authenticated connection to the server as the device and its user move about in space and time. The WHD may monitor and maintain its connection with the server and act appropriately (discussed below) when this connection is temporarily or permanently lost. Further, the WHD may utilize data encryption techniques and user authentication to enhance the secure connection for data transmissions between the WHD and the server. This user authentication may be maintained for the duration of that user's session and is available for the purposes of authenticating requests for data made by the client application on the WHD.

Once the client application on the WHD has established a connection to the HCIS, the user may search for and select patients in a number of ways (i.e. a patient lookup component, a provider schedule, a private or shared roster, a personalized rounding list, the current hospital census, etc.), to document encounters with the patient, to capture charges for patient care, to review the patient's medical history, and to order medications, tests, and procedures with full decision support. The user is also able to access the workflow messaging system, schedules, and clinical reference materials, as well as other patient care and workflow collaboration functionalities.

In contrast, the asynchronous environment provided by the WHD of the prior art creates potential data conflicts, and additional work is required to solve these data conflicts. In addition, such an environment creates a situation where the correct data exists in one place and not another, either on the WHD and/or the local data store, or in the patient health record repositories themselves. This disjunction either prevents all users (handheld and workstation-based) from realizing the full potential of the patient health record repositories by either preventing them from performing patient care tasks that require up-to-date information, or by introducing the possibility that they are performing these tasks without complete and up-to-date information.

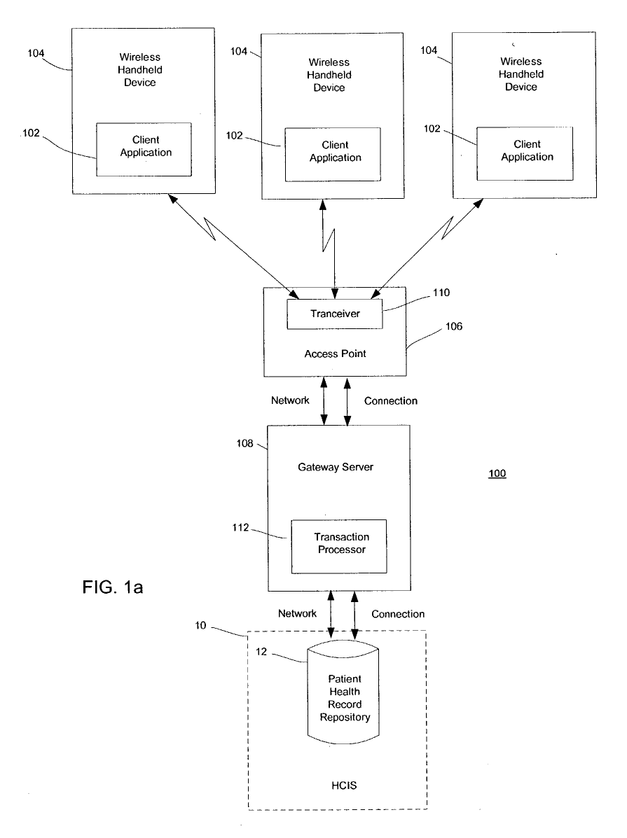

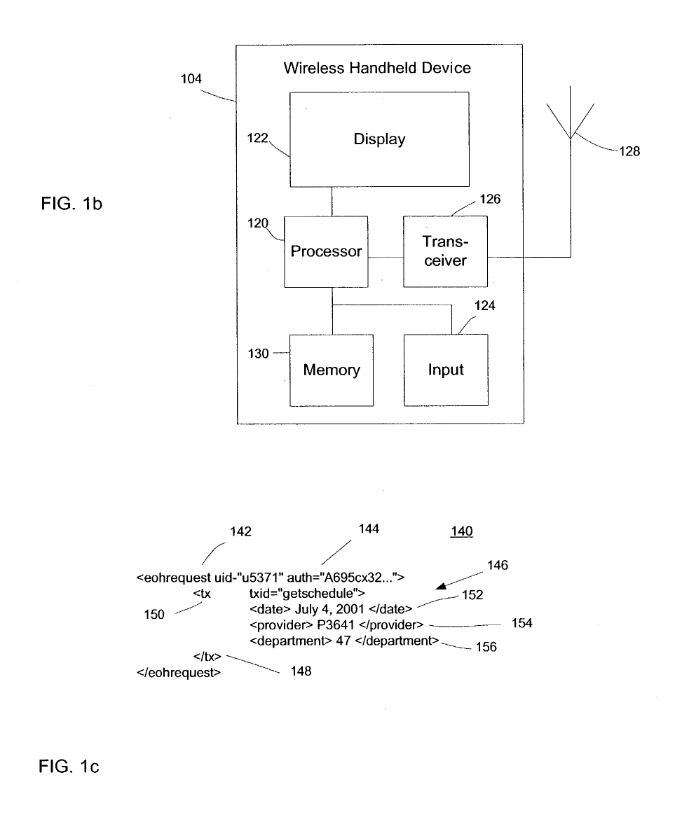

FIG. 1a is a block diagram of a system 100 for real-time access to the HCIS 10 using a client application 102 running on a wireless handheld device (WHD) 104, an access point 106 (for example including a communications transceiver 110), and a gateway server 108. The client application 102 runs on the WHD 104, which is capable of communicating with the access point 106 via, for example, encrypted Hypertext Transfer Protocol-Secure (HTTPs) messages using a Secure Socket Layer (SSL) encryption method. As illustrated in FIG. 1a, more than one, and in fact several WHDs 104 may simultaneously operate in the system 100. A block diagram of the WHD 104 is illustrated in FIG. 1b. While only a single access point 110 is illustrated, it will be appreciated that multiple access points talking to a single or multiple, e.g., gateway pools, gateway servers 108 may be employed to provide complete coverage of the environment in which the WHDs 104 are to be used. While not shown, it will be appreciated that suitable security in the form of firewalls and other network security arrangements are provided to ensure the integrity of the system 100. For example, multiple levels of firewalls may be provide, one specific to the HCIS 10 and another securing the access point 106, gateway server 108 and HCIS 10 network.

As shown in FIG. 1b, the WHD 104 includes a processor 120 for controlling operation of the WHD 104. The processor 120 is coupled to a display 122 for displaying information to a user of the WHD 104, and to an input device 124 (for example an alpha-numeric keypad or voice interface), allowing a user of the WHD 104 to input information to the WHD 104. Further the processor 120 is coupled to a transceiver 126 which is further coupled to an antenna 128 for sending information to, and receiving information from, the HCIS 10 via radio frequency (RF) transmissions. Radio frequency transmissions may be used as may other forms of wireless data communication including infra-red (IR) transmission and/or combinations thereof. A suitable data transmission protocol may be used, for example the IEEE 802.11a or 802.11b protocols may be used. The processor 120 is further coupled to a memory 130 of the WHD 104, for storing information, and programming for implementing functionality on the WHD 104 and particularly the client application 102. Although the display 122 and input device 124 are shown as separate components of the WHD 104, one skilled in the art would realize that they may be integrated into a single device, for example, a touch screen display.

Referring to FIGS. 1a and 1b, the client application running 102 on the WHD utilizes the display 122 and input device 124 in providing a graphical user interface for accessing applications of the HCIS 10, and for modifying information stored in the HCIS 10 and patient health record repository(ies) 12 therein, and is capable of formulating data requests and messages in response to user action, and sending them to the gateway server 108 via the access point 106. The client application 102 further receives and interprets responses to data requests and messages sent to the HCIS 10 via the gateway server 108, and is capable of evaluating the state of its live, real-time connection with the gateway server 108 via the access point 106. An example message format for communicating between the WHD 104 and the HCIS 10 is illustrated in FIG. 1c.

FIG. 1c illustrates an eohrequest message 140 that may be utilized for sending information between the WHD 104 and the HCIS 10. As shown in FIG. 1c, the eohrequest message 140 is in the form of an extensible markup language (XML) instance, embedded within the HyperText Transport Protocol (HTTP) and Transmission Control Protocol/Internet Protocol (TCP/IP) communication protocols as would be appreciated by one skilled in the art.

The eohrequest message 140 includes a user ID 142, an authentication code 144, one or more transactions 146, and code 148. The transactions may utilize mnemonics, and include one or more parameters. For example, as shown in FIG. 1c, the transaction ID 150 is “getschedule,” where the transaction parameters 146 are “date” 152, “providerid” 154, and “department” 156: where date, provider and department information is provided through the transaction parameters 146. Although not shown, one skilled would realize that where other transaction IDs are utilized, appropriate transaction parameters to the particular transaction ID may be utilized. In one implementation XML messages may be parsed on the gateway 108 and the parsed data sent along to the HCIS 12. Alternatively, the XML messages may be passed directly to the HCIS 12, which would then be configured to include an agent to parse the messages.

Returning to FIGS. 1a and 1b, the client application 102 is further capable to direct operation of the processor 120 through its control program to store and maintain session-specific user authentication and timeout information for the user currently logged into the HCIS 10, and to notify the user of the current status of its live, real-time connection to the gateway server 108, and thus the HCIS 10 and patient health record repository(ies) 12.

The client application 102 is additionally capable to direct operation of the processor 120 for enabling and disabling functional components for accessing and modifying information of the HCIS 10, including patient data, according to the state of the live, real-time connection with the gateway server 108. Further, the client application 102 is capable to direct operation of the processor 120 for providing dualmode functional communication capability responsive to the state of the real-time connection with the gateway server 108 by way of dual-mode functional components. Dual-mode functional components (further described below) are components configured for using synchronous data derived from a live, real-time connection to the HCIS 10 and patient health record repository 12 via the gateway server 108 when such a connection is available, and for using asynchronous data stored on the memory 130 of the WHD 104 when a live, real-time connection is not available.

The communication transmitter 110 is capable of sending encrypted messages to the WHD 104, and receiving encrypted messages from the WHD 104, and relaying these messages to the gateway server 108 via a standard network connection.

The gateway server 108 is capable of accepting messages from the client application 102 on the WHD 104 sent via the transceiver 126 and the antenna 128 and relayed by the communications transmitter 110. Within the gateway server 108 the transaction processor 112 is used to interpret these messages. These messages are relayed typically in a machine-readable format understood by the HCIS 10. The gateway server 108 further is capable of generating and maintaining session-specific user authentication and timeout information for each WHD 104 connected to the HCIS 10, authenticating messages received from the client application 102 on the WHD 104 before interpreting these requests with the transaction processor 112, accepting messages from the HCIS 10 and patient health record repository 12 that have been generated in response to requests sent by the client application 102 on the WHD 104, and relaying these messages to the client application 102 on the WHD 104 via the access point 106.

The gateway server's transaction processor 112 includes a tabular map (not depicted) that relates a unique transaction mnemonic to a particular functional component programmatic identifier (ProgID). This mnemonic/ProgID map allows the transaction processor to interpret a data request from the client application 102 on the WHD 104 by matching the mnemonic to a specific functional component which in turn invokes methods that get data from and send data to the patient health record repository 12.

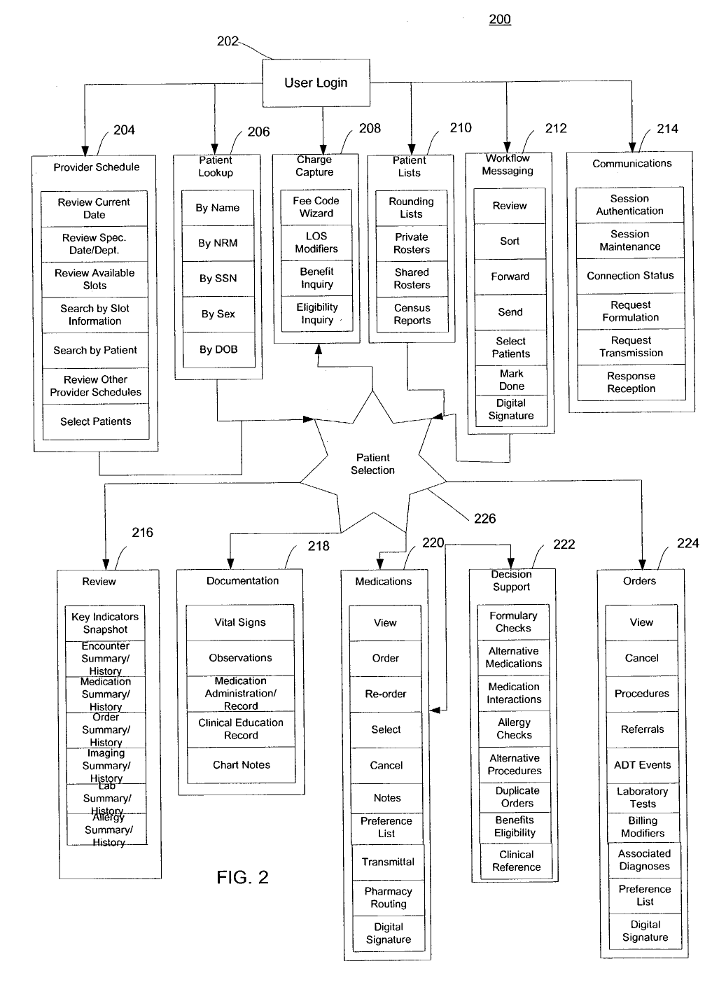

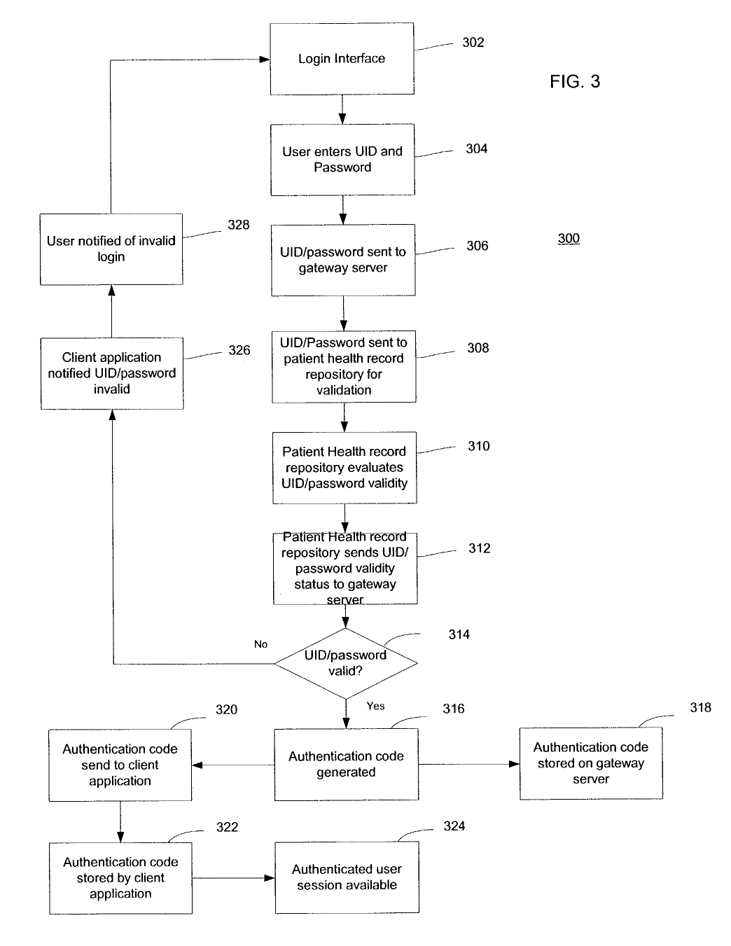

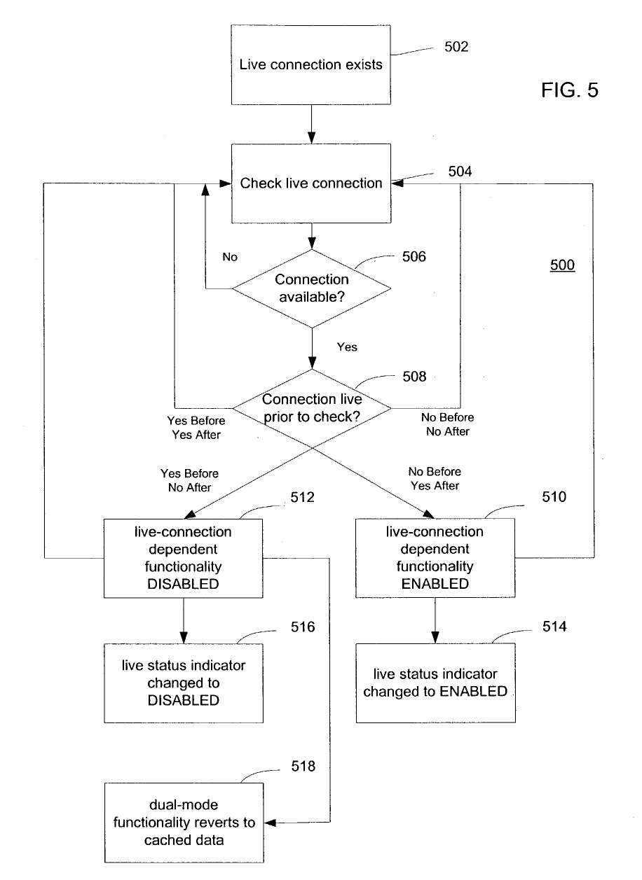

FIG. 2 illustrates a client application 200, e.g., client application 102, implementable on the WHD 104. The client application 102 typically runs as software on the WHD 104 and interacts with the HCIS 10 and patient health record repository 12 via the gateway server 108. While as generally described herein the client application 102 is described as providing a function, performing a task, sending, receiving or operating on data and the like. It will be appreciated that the client application 102 may be a software program or software programs that cause the processor to operate in accordance with the program logic for affecting the desired functionality. A user of the WHD 104 using a login process 202 logs into the HCIS 10 by entering a user identification (UID)/password combination, which is then validated by the HCIS 10, discussed below with respect to FIG. 3. After the user logs in, the client application's current user session is checked and maintained, discussed below with respect to FIG. 5. Once the user has successfully logged into the HCIS 10 and the user's session has been authenticated, the user may access any number of client application functional components including provider scheduling 204, patient lookup 206, charge capture 208, patient lists 210, workflow messaging 212, communications 214, review 216, documentation 218, medications 220, decision support 222, and orders 224. The WHD 104 allows selection of a patient(s) 226 (and information corresponding to that patient), as well as access to other data and functionality provided within the HCIS 10.

Regarding provider scheduling 204, where the user is also a health care provider (as recognized by the system), when a live connection is available (WLAN/sync “dual mode”) he may review his provider schedule for the current date or for specific date/department combinations. The provider may also search for slots on the schedule by availability or by slot information such as time, visit type, length, etc. The provider may also review the schedules of other providers, if his security profile and access privileges allow. In addition, the provider may search his schedule for individual patients, select individual patients and open their patient health records from his provider schedule.

Regarding patient lists 210, a user may access patient lists of a number of types to select a patient(s) via the client application, including but not limited to rounding lists, private rosters, shared rosters, and census reports. The user can then select individual patients from these list and open their patient health records.

Regarding workflow messaging 212, a user may access the client application's workflow messaging component in order to review messages of any number of pre-defined types, sort messages according to priority and other criteria, forward messages to other staff, send new messages to individual staff members or groups of staff members, mark messages to indicate that the tasks associated with messages have been completed, and attach a digital signature of messages of certain types. In addition, when a message pertains to an individual patient, the user may select that patient and open that patient's health record for further action.

Regarding patient lookup 206, a user may search for patients by name, medical record number (MRN), Social Security number (SSN), by sex, by DOB, or other pre-defined mnemonics. Once the desired patient has been found, the user may then select the patient and open the patient's health record for further action.

Regarding medications 220, once a patient has been selected, a user may access the client application's medications component in order to view, re-order, and cancel the selected patient's current medications, to order new medications for the selected patient, to append chart notes to specific medication orders, etc. In addition, the user can select medications by name, synonym or alias, as well as from pre-defined preference lists. The medications component may also allow the user to append a digital signature to medication orders and cancellations, to configure how medication orders are transmitted, and to route medication orders directly to a pharmacy of the user's choice.

Regarding orders 224, once a patient has been selected, a user may access the client application's orders component in order to view, order, route, and cancel orders for procedures, referrals, admission, discharge and transfer (ADT) events, laboratory tests, etc. The orders component may also allow the user to append a digital signature to orders and cancellations, to associate diagnoses for billing purposes, and to select billing modifiers. In addition, the user may select procedures and laboratory tests from pre-defined preference lists. Further, orders may be checked for duplicate medications, procedures, tests, referrals, etc.

Regarding review 216, once a patient has been selected, a user may access the client application's review component in order to view the patient's key indicators snapshot, as well as the summary and the history of the patient's encounters, medications, orders, imaging, laboratory tests, and allergies.

Regarding documentation 218, once a patient has been selected, a user may access the client application's documentation component in order to document the patient's vital signs, other medical observation data, medical administration record, and clinical education record. In addition, the user may also create additional chart notes for the selected patient. Further, a user may create a new patient encounter, or close an existing patient encounter.

Regarding charge capture 208, once a patient has been selected, a user may access the client application's charge capture component in order to specify the charges associated with procedures and services provided by the user. The user may use a multi-level, interactive professional fee code wizard and a level of service calculator to correctly determine the appropriate charges. In addition, the user may also inquire into the selected patient's benefits and eligibility.

Regarding decision support 222, once a patient has been selected and the user has accessed a given component, the client application 102 provides automated decision support so that the user can provide high quality patient care more efficiently. When ordering medications, the user may check the current formulary for the desired medications and for alternative medications. The client application 102 may also check for interactions between the medications selected for order and the medications on the patient's current medication list. The client application 102 also checks the patient's known medication allergies to determine of the patient is known to be allergic to the medications selected for order. When ordering procedures, the user may check for alternative procedures. In addition, the client application 102 may also check any given medication, procedure, ADT event, or laboratory test order to determine whether the given order is a duplicate of another order so that such duplication can be prevented.

In a further embodiment, a given user's access to the client application's functional components provided on the WHD 104 may be limited to a pre-defined subset according to that user's security profile and access privileges of the HCIS 10.

In another embodiment, the information displayed or provided to the user of the WHD 104 may be configured (for example, displayed in a different order) by the user.

FIG. 3 is a flow chart illustrating a process 300 for WHD 104 user authentication by the HCIS 10. When the user starts the client application 102 on the WHD 104, the user is presented 302 with a login interface. This login interface requires the user to enter 304 a unique identification (UID) and password combination to begin the login and authentication process. After the user enters the UID and password, the client application 102 formulates a transaction message, for example in the general XML format discussed above with respect to FIG. 1c, and submits 306 this transaction message to the gateway server 108. The gateway server 108 uses the transaction processor 112 to recognize the transaction message as a request for user authentication, and submits 308 the UID/password combination to the HCIS 10 for a validity evaluation 310. After the HCIS 10 has evaluated the UID/password combination for validity, it sends 312 the validation status of the submitted UID/password back to the gateway server.

Where the UID/password is determined valid 314 by the HCIS 10, the gateway server 108 generates 316 a random string of a prescribed length and format to serve as the authentication code for the user session in question. This authentication code is stored 318 on the gateway server corresponding to the UID, and sent 320 as part of a transactional response from the gateway server 108 to the client application 102 on the WHD 104. The authentication code is stored 322 by the client application in the memory of the WHD for later use in the transaction authentication process. The client application 102 on the WHD 104 then enables 324 the functional components appropriate to the current user's security profile and role.

Where the UID/password is determined invalid 314 by the HCIS 10, the gateway server 108 generates a transaction message which is sent 326 to the WHD 104 and notifies the client application 102 that the UID/password which was entered is invalid. The client application 102 notifies the user that the UID/password is invalid 328, and then returns the user to the login interface 302 and awaits further user action.

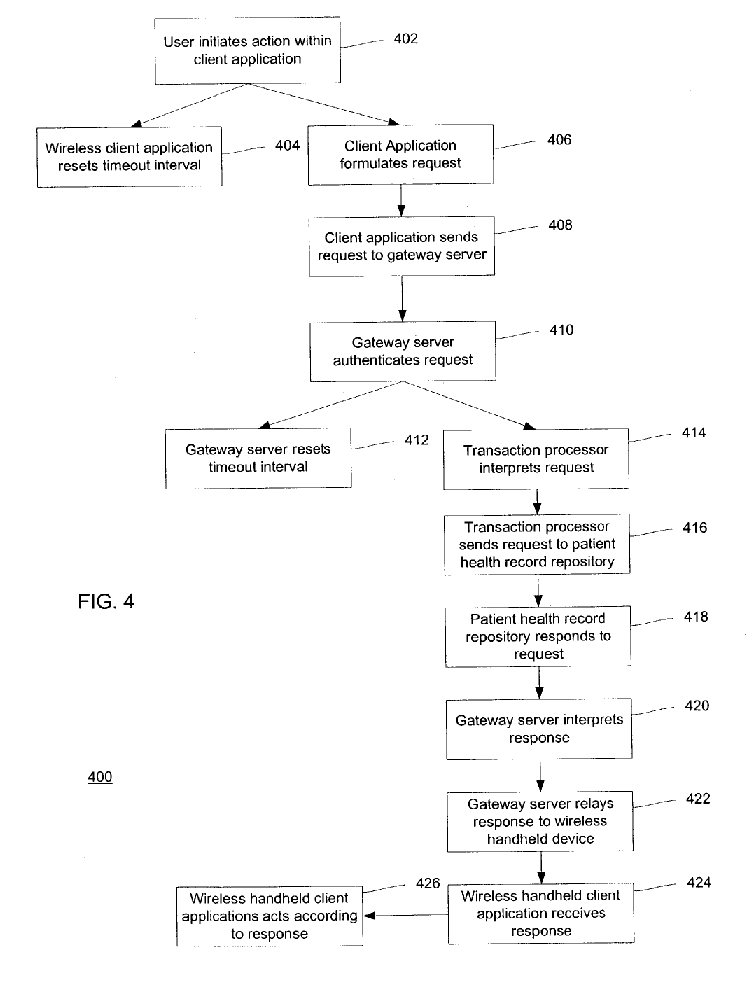

FIG. 4 is a flow chart illustrating a process 400 for HCIS transaction processing. Once the user has successfully logged in to the system 100 and the live, real-time connection between the client application 102 on the WHD 104 and the gateway server 108 is available, the client application 102 is then able to access functionality of and/or get data from and send data to the HCIS 10 and patient health record repository 12 via the gateway server's transaction processor 112 in response to user-initiated actions.

When the user initiates 402 an action that requires the client application 102 on the WHD 104 to access functionality or get data from or send data to the HCIS 10 and the patient health record repository 12, the client application 102 formulates 406 a request message, for example in the format discussed above with respect to FIG. 1c, including the current user's UID and the current session-specific authentication code, as well as one or more transactions. Each transaction is identified by a unique mnemonic and may also contain one or more parameters (i.e., patient ID, provider ID, etc.). Once the client application 102 has formulated the request message and a live, real-time connection with the gateway server 108 exists, the client application 102 sends 408 the message to the gateway server 108 for processing and resets 404 its timeout interval for the current session. When the gateway server 108 receives the request message from the client application 102 on the WHD 104, it compares the UID and authentication code included in the request to the UID and authentication code stored on the gateway server 108 to determine 410 whether the request message is part of a current and authenticated session. As a part of the authentication process, the gateway server 108 may also reset 412 its timeout interval for the current session.

After the gateway server 108 authenticates the request message, it uses the transaction processor 112 to interpret 414 each of the transactions that make up the request message. The transaction processor 112 interprets each transaction contained in the request message by matching the transaction's mnemonic with the programmatic identifier (ProgID) associated with that mnemonic in a pre-defined tabular map maintained by the transaction processor 112. After the transaction processor has matched the transaction mnemonic to the appropriate ProgID, it invokes the functional component represented by the ProgID and provides the functional component with the parameter data that was included in the transaction.

Functional components represented by a ProgID in the transaction processor's mnemonic/ProgID map may be specifically designed to interact with, send data to, and get data from a specific sector of the HCIS 10 and patient health record repository 12. When a given functional component has been invoked, it sends 416 a message to the HCIS 10 and patient health record repository 12. The HCIS 10 and patient health record repository 12 processes 418 these requests and returns the response to the gateway server 108, which interprets the response 420. If a live, real-time connection between the gateway server 108 and the WHD 104 is available, the gateway server 108 relays 422 the message to the client application 102 on the WHD 104. When the client application receives 424 the response to its message request, it parses the response according to the type of request/response and makes the data contained in the response available 426 to the user in the manner appropriate to the specific functional component and the content of the data. Further, the functional components represented by the ProgID may be designed to provide functionality directly or indirectly to the WHD 104, through the live wireless connection between the WHD 104 and the gateway server 108.

Before providing access to various functionality or data of the HCIS 10, security of the user of the WHD 104 may be checked to ensure that the user has sufficient security clearance to access functionality/data of the HCIS 10. Such security control may be provided by the WHD 104 based on security information present within the WHD 104, or may be provided at the gateway server 108, access point 106 or HCIS 10 based on information present within those components or information received from the WHD 104.

FIG. 5 is a flow chart illustrating a process 500 for checking and maintenance of a live, real-time connection between the WHD 104 and the gateway server 108.

Once the client application 102 on the WHD 104 has initiated a user-specific session and established 502 a live, real-time connection with the gateway server 108, the client application checks 504 the status of this connection at a prescribed interval for the duration of the current session. The client application checks the status of its connection to the gateway server by first submitting a query 506 to the WHD's operating system to determine whether a network connection is available. If a network connection is available, the client application 102 then sends a ICMP echo (commonly known as PING) request to the gateway server 108. If the gateway server 108 replies to this request with a response of the same format within a prescribed period of time, the live, real-time connection with the gateway server is considered intact. If the gateway server 108 does not send an ICMP echo (PING) response to the client application 102 on the WHD 104 within the prescribed period of time, the connection is considered lost or interrupted.

Where the live, real-time connection between the client application 102 on the WHD 104 and the gateway server 108 is available, the client application determines 508 whether the connection was available prior to the current check. If the connection was available prior to the current check, the client application 102 continues to operate as before, and waits for the next check. If the connection was not available prior to the current check, the client application 102 enables 510 functionality dependent on the live, real-time connection to the gateway server 108 which was previously disabled due to loss of the live connection, and notifies 514 the user that the connection is once again available.

Where the live, real-time connection between the client application on the WHD and the gateway server is not available, the client application determines whether the connection was available prior to the current check. If the connection was not available prior to the current check, the client application continues to operate as before, and waits for the next check. If the connection was available prior to the current check, the client application disables 512 functionality which is dependent on the live, real-time connection to the gateway server 108, and notifies 516 the user that the connection is unavailable. Such notification may be provided via a symbol or text displayed on the display of the WHD 104, audibly, or in any other fashion sufficient for notifying the user of the WHD 104 that the connection has been lost.

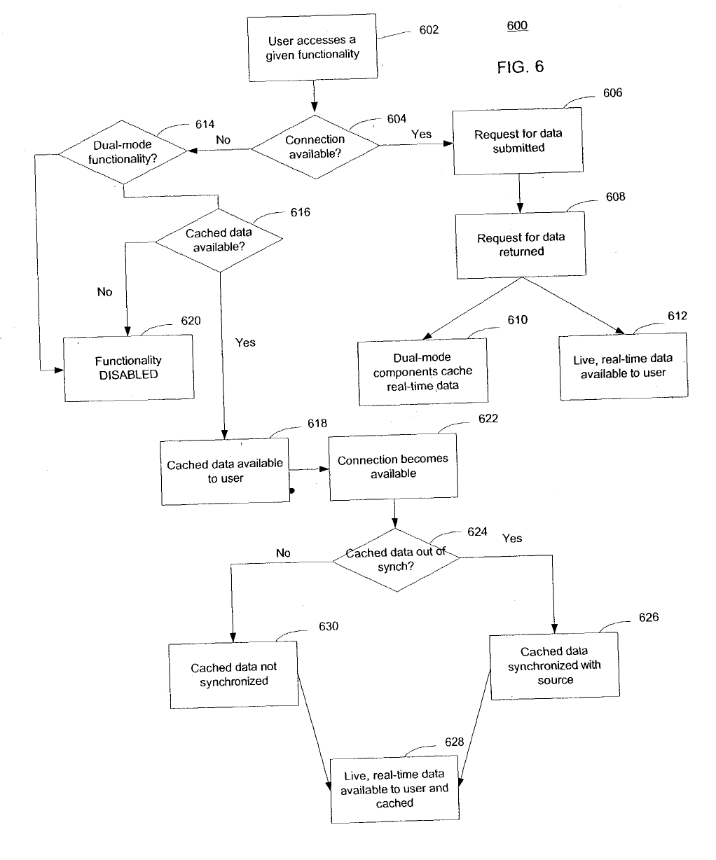

In a further embodiment, data may be cached 518 on the WHD 104, and made available for dual-mode functional components of the client application, where the client application reverts to the cached data for using the dual-mode functional components when a live, real-time connection between the WHD 104 and the HCIS 10 and patient health record repository 12 is unavailable. Dual-mode functional components are further discussed with respect to FIG. 6.

FIG. 6 is a flow chart illustrating a process 600 for use of dual-mode functional components when switching between synchronous and asynchronous environments on the WHD 104, in accordance with an embodiment of the invention.

As discussed above relative to the process 500, when a user attempts to access 602 a given functional component of the client application 102 on the WHD 104, the client application 102 determines 604 whether a connection is currently available by checking the status of the last connection check. If a live, real-time connection is currently available, the client application 102 formulates a request message (for example, as discussed above), sends 606 this request to the HCIS 10 via the gateway server 108 and the transaction processor 112. The HCIS 10 returns 608 the requested data, and the client application 102 then makes the data contained in the response available 612 to the user in the manner appropriate to the specific functional component and the content of the data. In this case, if the functional component in question is configured for dual-mode operation, the client application 102 also caches 610 the data contained in the last real-time request/response transaction.

However, where a live 604, real-time connection between the WHD 104 and the gateway server 108 is not currently available, the client application 102 determines 614 whether the functional component that the user is attempting to access is configured for dual-mode operation. If the functional component is configured for dual-mode operation, the client application 102 then determines 616 whether cached data is available on the WHD 104 for that component. If cached data is available, the client application 102 enables the component and presents the data 618 to the user in the manner appropriate to the specific functional component and the content of the data. If cached data is not available for a given dual-mode component, or the component is not configured for dual-mode operation, the client application 102 disables 620 the component.

If the live, real-time connection becomes available 622 between the WHD 104 and the gateway server 108, the client application 102 determines 624 whether the cached data associated with dual-mode functional components is out of synchronization with the information in the HCIS 10 (i.e. in the patient health record repository 12). If so, the data cached by the client application 102 on the WHD 104 is synchronized 626 with the HCIS 10 via the wireless connection. The new, synchronized data derived from a live, real-time connection is then cached 628 by the client application and made available to the user in the appropriate manner. If the data cached by the client application 102 on the WHD 104 is not out of synchronization, the data cached by the client application 102 is not synchronized 630.

Thus, various functionality provided by the WHD 104 may be dual-mode as it may operate under both synchronous and asynchronous environments, for example where the live connection is available, and where the live connection with the gateway server is unavailable, respectively.

The client application 102 discussed herein has been described as including various functionality, however, one skilled in the art would realize that less functionality may be included within the client application while still achieving advantages of the invention. Further, although the client application 102 has been described as implementing the various functionality in the form of software residing on the WHD 104, one skilled would realize that some or all of the functionality need not be provided by the WHD 104, but rather by other portions of the HCIS 10, where the WHD 104 acts as more of a wireless graphical interface for the user with the functionality and/or data present within the HCIS 10. Further, as discussed above, the WHD 104 need not maintain a constant connection with the access point 106 while still achieving advantages discussed herein. For example, where communication with the access point 106 is temporarily lost, dual-mode functional components may be utilized as discussed above.

A HCIS 10 as discussed above provides user the ability to provide health care to patients in various contexts. Typically, the HCIS 10 may include a patient health record repository 12 comprised of one or more databases or data repositories that store patient healthcare data and related healthcare business data using one or more database management systems that run on one or more computing platforms on one or more computing devices. The HCIS 10 may additionally include one or more end-user client applications (including web browsers) that run on one or more computer operating systems on one or more types of computing devices, including but not limited to workstations, wireless handheld computing devices, wireless laptop computing devices, and web appliances. Further, the HCIS 10 may include one or more servers of multiple types to facilitate communication between the end-user client applications and the HCIS 10 and patient health record repository 12, including but not limited to web servers, gateway servers, application servers, terminal servers, and database servers. Additionally, the HCIS 10 may include a computer network comprised of industry standard network hardware (routers, switches, connectors, etc.) and software (network and communication protocols) that serves to allow communication between the patient health record repository, the end-user client applications running on various device types, and the various types of servers. This network may take the form of a cable-based or fiber optic network, a wireless local area network (LAN), a wireless wide area network (WWAN), a virtual private network (VPN), the Internet, or any other type of wired or wireless network that allows communication between computing devices.

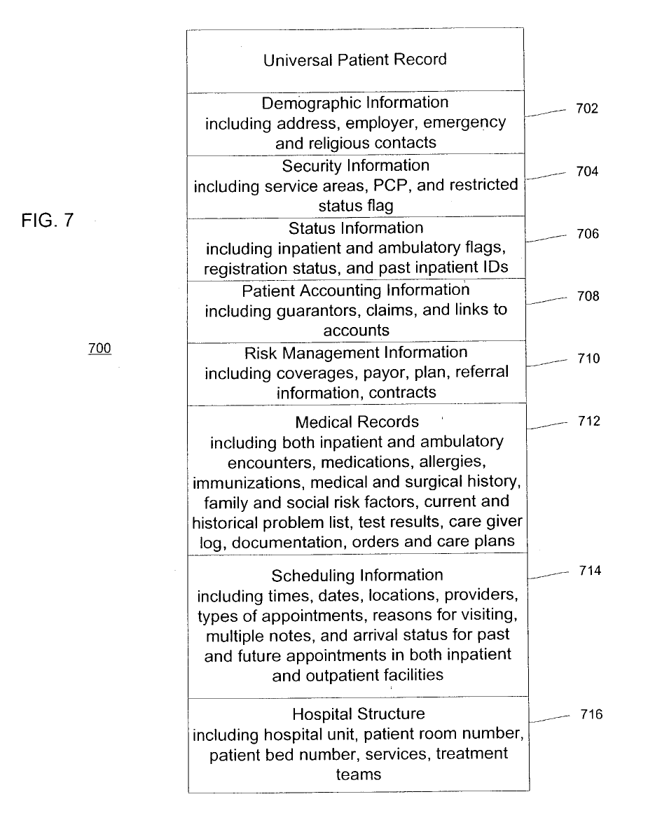

The patient health record repository 12 of the HCIS 10 may utilize, for example, a universal patient record (UPR), shown in FIG. 7, and as described in the commonly assigned U.S. patent application entitled “System and Method for Integration of Health Care Records,” to Dvorak, et al., application Ser. No. 10/007,066, the disclosure of which is hereby expressly incorporated by reference. The UPR includes information regarding health care delivery, and information regarding health care delivery management for a particular patient. The information in the UPR may include patient demographic information, security information, status information, patient accounting information, risk management information, medical records, scheduling information, and hospital structure information. Information regarding health care delivery may include medical records. Information regarding health care delivery management may include patient demographic information, security information, status information, patient accounting information, risk management information, scheduling information and hospital structure information. The UPR may be one of many UPRs within a health care system, where each UPR maintains demographic, security, status, accounting, risk management, medical record, scheduling and hospital structure information for corresponding patients. As also discussed above, the data stored in each UPR may be formatted text/data, links to formatted text/data, or selections from a list of available data.

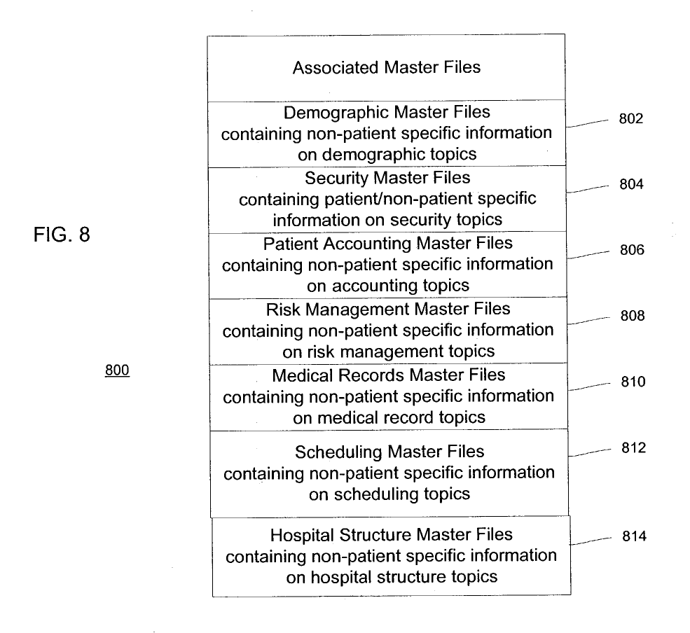

The UPR, such as the UPR 800 shown in FIG. 8, typically includes associated files 802-816, further maintained in the central data repository. The master files 900 (FIG. 9) may include demographics master files 902 which include non-patient-specific information on demographics topics, security master files 904 which include non-patient-specific information on security topics, and patient accounting master files 906 which include non-patient-specific information on accounting topics. The master files may further include risk management master files 908 which include non-patient-specific information on risk management topics, medical record master files 910 which include non-patient-specific information on medical record topics, scheduling master files 912 which include non-patient-specific information on scheduling topics, and hospital structure master files 914 which include non-patient-specific information on hospital structure. The one or more UPRs of the health care system include links to records/files in corresponding master files, allowing patient-specific information to be stored in a manner that supports integrated features.

Alternatively, the patient health record repository may comprise multiple databases residing on one or more storage media, interfacing with a single health care application or multiple health care applications comprising an HCIS, as would be appreciated by one skilled in the art. In addition, the HCIS 10 and WHD 104 may utilize a seamless user interface as described with respect to commonly assigned U.S. patent application entitled “A System and Method for a Seamless User Interface For an Integrated Electronic Health Care Information System,” to Brummel, et al., application Ser. No. 10/007,620 the disclosure of which is hereby expressly incorporated herein by reference, or may be provided in any other fashion allowing health care services to be performed.

Although the HCIS 10 has been shown as a separate component from the WHD 104, the WHD 104 may be embedded within the HCIS 10. One or more transceivers may be provided within the access point 106 for establishing a connection with the WHD 104. Further, the wireless connection established by the WHD 104 may utilize RF, infra-red, ultra-sonic, optical, or any other wireless transmission medium or means known. Although the communication message format between the WHD 104 and the access point 106 has been described as utilizing an XML schema embedded within HTTP and TCP/IP protocols, other message formats may be utilized, commensurate with the medium of transmission, without departing from the scope of the invention.

The invention has been described in terms of various embodiments. It will be appreciated that the invention may otherwise be embodied without departing from the fair scope of the invention disclosed herein.

1. A method of wirelessly accessing a healthcare information system, the healthcare information system including a database containing patient related information, the method comprising:
providing an access point coupled to the healthcare information system, the access point including a transceiver for receiving transmitted signals from a wireless handheld device and for transmitting signals to the wireless handheld device;
receiving at the healthcare information management system from the wireless handheld device a request to access a functional component of the healthcare information system;
determining the status of a secure, user-specific connection between the wireless handheld device and the healthcare information system established via the access point;
determining an operational state of the requested functional component;
enabling the functional component in one of an asynchronous mode and a synchronous mode of operation based upon the status and the operational state.

2. The method of claim 1, providing a gateway server coupled between the access point and the healthcare information system.

3. The method of claim 1, wherein enabling the functional component in the asynchronous mode comprises utilizing cached data on the wireless handheld device.

4. The method of claim 1, comprising synchronizing the cached data with data contained within the healthcare information system upon detecting the existence of the secure, user-specific connection between the wireless handheld device and the healthcare information system.

5. The method of claim 1, wherein determining the status of the secure user-specific connection between the wireless handheld device and the healthcare information system comprises determining a current status of the secure, user-specific connection and a prior status of the secure user-specific connection.

6. The method of claim 1, wherein enabling the functional component in the synchronous mode comprises disabling the functional component until the secure, user-specific connection is determined to exist.

7. The method of claim 1, comprising accepting and verifying secure login data from a user.

8. A healthcare information system comprising:
an information repository;
a gateway server communicatively coupled to the information repository, the gateway server including a transaction processor;
an access point communicatively coupled to the gateway server, the access point including an access point transceiver;
a wireless handheld device including a processor, a memory and a device transceiver, a client application to direct operation of the processor, the processor having a first mode of operation and a second mode of operation defined by the client application based upon the existence of a secure, user specific wireless communication connection between the access point transceiver and the device transceiver.

9. The healthcare information system of claim 8, wherein the memory comprises cached data corresponding with a portion of the data stored in the information repository, and wherein the first mode of operation comprises an asynchronous mode of operation utilizing the cached data.

10. The healthcare information system of claim 9, the cached data being data periodically synchronized with the data stored in the information repository responsive to the existence of the secure, user-specific connection.

11. The healthcare information system of claim 8, wherein the second mode operation comprises a synchronous mode of operation utilizing in real time data stored in the information repository.

12. The healthcare information system of claim 8, comprising a functional component operable in either of the first mode of operation and the second mode of operation.

13. The healthcare information system of claim 8, comprising a functional component operable only in one of the first mode of operation and the second mode of operation.

14. The healthcare information system of claim 8, the information repository comprising a universal patient record.

15. A healthcare information system comprising:
means for establishing a secure, user specific wireless connection between a handheld device and an information repository;
the handheld device having a first operable mode utilizing cached data corresponding to a portion of data stored in the information repository, the first operable mode being dependant upon the existence of the secure, user specific wireless connection and a first requested functional component; and
the handheld device having a second operable mode utilizing real time data corresponding to a portion of the data stored in the information repository dependent upon the existence of the secure, user specific wireless connection and a second requested functional component.

16. In a healthcare information system including a information repository, a handheld device and a user, specific wireless connection between the handheld device and the information repository, a computer program for directing operation of the healthcare information system comprising:
a first routine defining a first operable mode wherein the handheld device utilizes cached data corresponding to a portion of data stored in the information repository, the first operable mode being dependant upon the existence of the secure, user specific wireless connection and a first requested functional component; and
a second routine defining a second operable mode wherein the handheld device utilizes real time data corresponding to a portion of the data stored in the information repository dependent upon the existence of the secure, user specific wireless connection and a second requested functional component.
